(19) United States
(12) Patent Application Publication
(10) Pub. No.: US 2013/0255050 A1
(43) Pub. Date: Oct. 3, 2013

(54) TOOL FOR ASSEMBLING A SECURING RING

(71) Applicants: Bernd Thomas, Rotterode (DE); Thomas Wagner, Bermbach (DE); Horst Hofmann, Unterschoenau (DE)

(72) Inventors: Bernd Thomas, Rotterode (DE); Thomas Wagner, Bermbach (DE); Horst Hofmann, Unterschoenau (DE)

(73) Assignee: RENNSTEIG WERKZEUGE GMBH, Viernau (DE)

(21) Appl. No.: 13/989,780

(22) PCT Filed: Nov. 12, 2011
(86) PCT No.: PCT/EP2011/069988

§ 371 Date: May 24, 2013

(30) Foreign Application Priority Data
Nov. 25, 2010 (DE) 10 2010 060 790.8

(51) Int. Cl. B25B 27/20

(52) U.S. Cl. CPC B25B 27/20
USPC 29/229

(57) ABSTRACT

The invention relates to a tool for assembling a securing ring. The tool comprises two adjusting limbs which are connected to each other in a rotary joint and each free end of which has gripping means for engaging into an assembly opening of the securing ring. The tool further comprises a spindle drive provided between the adjusting limbs for changing the distance between the adjusting limbs. According to the invention, the rotary joint is arranged on the adjusting limb ends opposite the free ends, and the spindle drive is arranged between the rotary joint and the free ends of the adjusting limbs.

### FIELD OF THE INVENTION

The invention relates to a tool for assembling a securing ring, preferably for securing rings with a diameter greater than 400 mm, according to the preamble of claim 1.

### BACKGROUND OF THE INVENTION

Securing rings are machine parts that are predominantly used to secure bolts in position in boreholes, or components, for example roller bearings on a shaft or axle or in an interior borehole. At least in the diameter range up to 400 mm they are standard parts. The rings encountered in mechanical engineering are standardized according to DIN 471 for shaft grooves and DIN 472 for borehole grooves; these embodiment forms are stamped as well as ground as a flat ring and exhibit two holes for disassembly and assembly using special securing-ring pliers.

For interior securing rings, when being used in a borehole groove, the ends of the securing ring are compressed together. For exterior securing rings, which are installed in the groove of a shaft, the ends of the securing ring are expanded for assembly. Therefore, varying securing ring pliers exist for the various securing rings.

From prior art, securing ring pliers or Seeger circlip ring pliers are known, for mounting securing rings or snap rings onto shafts or into boreholes. The front ends (pins) of the securing ring pliers, which are inserted into the boreholes of the securing ring, are as a rule round in cross section and may have grooves in the longitudinal direction.

In various industrial applications, for example in wind power facilities, mill trains or in the maritime industry, as well as in facilities to drill for oil or natural gas, especially large securing rings with a diameter of up to 1000 mm and sometimes more are used. Due to their weight and for the great tensile forces required for their assembly and disassembly, they are to be handled only while observing special safety precautions.

From DE 295 19 915 U1, pliers are known for exterior securing rings with a diameter of greater than 300 mm. The pliers are equipped with a toothed-rack safety device against spring-back action of rings under tension. The ends of the pliers are directed parallel from each other. The tips of the pliers extend in the direction of the longitudinal axis of the pliers and exhibit a groove-shaped indentation in the compression direction to the assembly openings of the securing ring. For very large rings, the leverage of the pliers is not sufficient to apply the requisite forces for spreading the rings. Due to the length necessary of the hand lever of the pliers, only limited use can be made of it to assemble interior securing rings.

DE 201 02 624 U1 describes a pliers-like device for assembly and disassembly of securing rings with a diameter greater than 400 mm. The device exhibits two arms that cross in the manner of scissor joints, the driving ends of which can be shifted by a spindle drive to alter the interval of the pins. The end of the spindle possesses a polygonal profile, on which a wrench can be applied to turn the spindle. For this, using one hand, the tool is held on a handle on one of the arms, and the screwdriver is manipulated with the other hand. For very heavy securing rings, this involves complicated handling. In addition, the tool itself that must be held in one hand is very heavy (over 3 kg), while the other hand is turning the screwdriver on the spindle end. Especially with heavy securing rings, this presents additional complications. Also, with this tool, the pins extend in the direction of the longitudinal axis of the tool, so that difficulties arise in turn in the assembly of interior securing rings.

From GB 2 067 453 A a compass-like tool is known for assembly or disassembly of securing rings. A spindle drive is provided between the adjusting limbs.

GB 1 190 946 A discloses a collet chuck for securing rings, which likewise is configured in the manner of a compass.

From U.S. Pat. No. 6,678,930 B1 a tool is known for assembly of a securing ring, which comprises two movable jaws, of which one is attached onto a handle. Between the jaws, which are connected by a rotary joint, a spindle drive is placed for moving the jaws.

### SUMMARY OF THE INVENTION

The object of the invention is to provide a tool for assembly or disassembly of securing rings, which is especially applicable for securing rings with diameters greater than 400 mm, with manipulation made possible simply and safely with a tool as light and compact as possible. The tool should be equally suited for assembly of exterior and interior securing rings with no structural alterations.

This problem is successfully solved by a tool for assembly or disassembly of a securing ring with the features of claim 1.

The tool comprises two adjusting limbs that are connected with each other by means of a rotary joint on their ends. On the free ends of the adjusting limbs, gripping means are provided for engaging into an assembly opening (an eye or hole) of the securing ring. A spindle drive for shifting the adjusting limbs is connected to act as a drive between the rotary joint and the free ends of the adjusting limbs with the adjusting limbs.

The advantages of the invention are especially seen in that the tool is relatively small and light and easy to handle. Despite this, great force can be applied to the securing ring, so that also very large rings can be placed under tension without danger and can be mounted on components.

In an especially preferred embodiment form of the invention, at least one of the two adjusting limbs exhibits two limb sections that are tangent-bent to each other. Alternatively, the adjusting limbs, or at least one of them, can also be bent to form an arc. By this means, overall, a substantially wider range of adjustment can be attained. This is especially advantageous for tightening of exterior rings, in which the gripping means must be brought adjacent to each other for the tightening.

The adjusting limbs can be designed as one piece or multiple pieces.

In the embodiment form in which both of the adjusting limbs are tangent-bent, the spindle drive for example is placed on the limb section facing toward the gripping means. The angle between the limb sections in the preferred embodiment for is 90°, but can be designed to be greater.

The spindle drive preferably is formed by an adjusting spindle supported so as to turn and pivot in the adjusting limbs, wherein in at least one of the adjusting limbs a threaded bushing is provided, which is connected to be drive-mobile with the adjusting spindle. The spindle drive preferably is designed to be self-locking, to prevent an undesired change in position of the adjusting limbs due to tension or compression on the tensioned securing ring. Also additional securing mechanisms can be provided, to prevent an undesired operation of the spindle drive.

Also, in a known manner, the spindle drive may exhibit two contra-directional threaded sections, each of which is supported in a threaded bushing in one of the adjusting limbs. Then, when the threaded spindle is turned, both limbs move relative to each other, and fewer revolutions of the threaded spindle are needed than with a threaded section, to achieve the same change in interval of the adjusting limbs.

In one especially preferred embodiment form of the invention, for turning of the threaded spindle, an angular gear is placed on the threaded spindle, preferably between the adjusting limbs. The angular gear makes it possible for both of the operator's hands to be in a favorable posture when tightening the securing ring. Preferably the angular gear in a first gear stage is connected with a set screw, so that by turning the set screw, the adjusting limbs change their relative position. By selecting a favorable gear ratio of the angular gear, easy manual operation can be attained.

In a varied embodiment form, the angular gear exhibits a second gear stage, which, by means of an incursion point, permits operation of the spindle drive using a motor-driven tool, such as a battery-powered screwdriver. The incursion point can be designed as an inner hexagon, inner round (Torx) or as a hexagon or the like. The operator can select the desired operating mode and gear stage. If necessary, a free-wheel can be provided between the two gear stages, to prevent an undesired operation of the other gear stage. The second gear stage can advantageously operate at a gear ratio altered vis-à-vis the first gear stage.

Preferably the gripping means can be designed in a known manner as pins, which are available in a straight shape, or, especially preferred, in angled form, and which preferably are attached so as to be replaceable on the adjusting limbs. For various kinds of securing rings, naturally various kinds of pins can be produced.

It has proven to be advantageous to have the pins bent by 90° to the position of the adjusting limbs, i.e., to the main plane of extension of the tool. It is especially appropriate if the bent pins run in the direction of a pivoting axis of the rotary joint, about which the adjusting limbs are pivoted. By this means, in a simple manner, the pins always stay in a parallel setting to each other, so that when the securing ring is tightened, it stays in its natural planar position and no stresses appear in other directions. By this means, the danger of the ring snapping off is reduced, which in the prior art must be implemented by relatively expensive parallel guidance.

In all the embodiment forms, the pins can exhibit all of the features known per se for securing the securing rings in position, such as groove-shaped indentations, eccentric head plates or the like.

### BRIEF DESCRIPTION OF THE DRAWINGS

One preferred embodiment form of the invention is explained in greater detail in what follows using the figures. Shown are:

FIG. 1 shows an invention-specific tool for assembly or disassembly of a securing ring in a half-opened setting.

FIG. 2 shows the tool as per FIG. 1 in a closed setting.

FIG. 3 shows the tool as per FIG. 2 in a three-dimensional view.

FIG. 4 shows a detail depiction of an angular gear provided on the spindle drive of the invention-specific tool.

### DETAILED DESCRIPTION

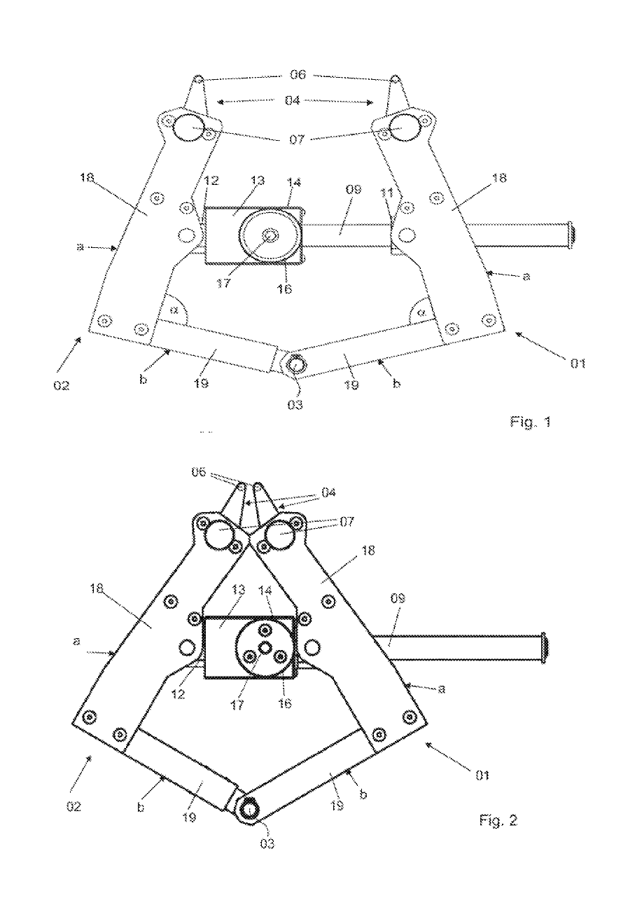

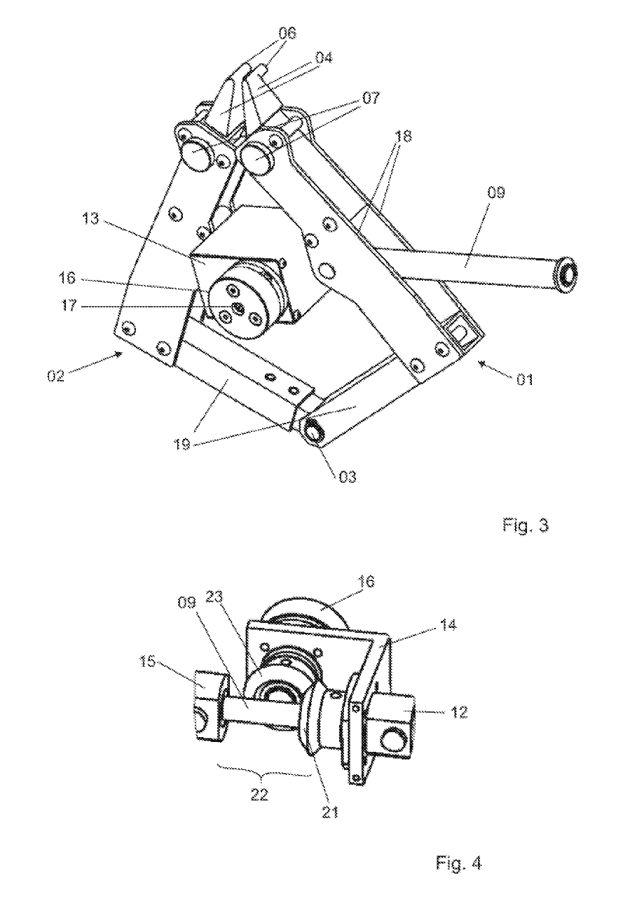

In FIGS. 1 to 3, an invention-specific tool is shown for assembly or disassembly of a securing ring not shown. FIGS. 1 and 2 show side views in a half-opened and closed setting, and FIG. 3 a three-dimensional view.

The tool comprises two adjusting limbs 01, 02, which are joint-connected with each other in a rotary joint 03. The rotary joint 03 is provided on the first ends of the adjusting limbs. The adjusting limbs 01, 02 carry gripping means 04 on their second, free ends to admit the securing ring to be tightened during assembly. In the embodiment form depicted, the gripping means 04 comprise a pin 06 angled inward in the image plane (FIGS. 1 and 2) to admit the securing ring in its assembly openings. Thus the pins 06 extend at a right angle to the main plane of extension of the tool.

In the embodiment form depicted, the adjusting limbs 01, 02 each comprise two limb sections a, b, which are bend-connected to each other about an angle α. In the embodiment form depicted, the angle α amounts to about 90°. In the simplest case, the two limb sections of an adjusting limb are connected to each other in fixed fashion. According to a varied embodiment form, the angle α between the limb sections is changeable. By adjusting the angle, the tool can be adapted to special installation situations, for example to be adapted over its entire width to the structural space available.

The gripping means 04 are situated so as to be replaceable on the free ends of limb section a, and preferably secured by manual screws 07. Preferably the gripping means are inserted into longitudinal guides in the free ends of the adjusting limbs 01, 02, which are dimensioned to be sufficiently stable to admit the in part large torques in tightening large securing rings.

A spindle drive, comprising a threaded rod 09, a threaded bushing 11 and a bearing bushing 12, is situated to be drive-active between the adjusting limbs 01, 02, here between the limb sections a of adjusting limbs 01, 02. The threaded bushing 11 is attached so as to pivot in adjusting limb 01. The bearing bushing 12 is attached so as to pivot in adjusting limb 02. The adjusting spindle 09 is supported so as to rotate in bearing bushing 12 and in threaded bushing 11, so that the threaded spindle 09 turns, the adjusting limbs 01, 02 are shifted toward each other.

On the threaded spindle 09, preferably between the adjusting limbs 01, 02, an angular gear 13 is situated in a housing 14. The angular gear 13 exhibits at least one adjusting wheel 16 for driving the threaded spindle 09. A preferred embodiment form of the angular gear 13 is explained below using FIG. 4. Additionally, on angular gear 13 an engagement point is provided, here in the form of an interior hex nut 17, which is able to be coupled for example with a motorized drive, for example with a battery-powered screwdriver or the like, for operation with a motorized drive. Preferably this engagement point 17 has a second gear stage assigned to it.

It can be perceived in FIG. 3 that the limb sections a are each formed by two plates 18 at parallel intervals, between which, on one of their ends, the limb sections b are mounted at a corresponding angle α. The threaded bushing 11 and bearing bushing 12, as well as the gripping means 04, are likewise attached between the plates 18 of the limb section a. The plate-like design is known to one skilled in the art from pliers-like tools and needs no more detailed explanation here.

The limb sections b are configured as profiles, preferably as hollow profiles 19, and thus the tool achieves high loading capacity and a relatively low weight.

FIG. 4 is a three-dimensional depiction of a possible embodiment form of the angular gear 13. Its housing 14 is provided with the bearing bushing 12 and a second bearing bushing 20 for rotating support of the threaded spindle 09. The bearing bushing 12 is mounted so as to pivot in adjusting limb 02, which is not depicted here.

A first gear stage comprises a first bevel-gear wheel 21, which is connected with the threaded spindle 09 in torsionally stable fashion. Preferably in one gear section 22, the threaded spindle 09 exhibits no threading. A second bevel-gear wheel 23 is supported so as to swivel in the housing 14 of angular gear 13, and is connected with the adjusting wheel 16 in torsionally stable fashion. The bevel-gear wheels 21, 23 are in angular engagement with each other in a known manner, wherein the numbers of teeth determine the ratio of the angular gear. The configuration and variation of the depicted angular gear 13, also as a two-stage gear, pose no difficulties for one skilled in the art.

1. Tool for assembly of a securing ring having:
two adjusting limbs connected with to other in a rotary joint, each having a free end on which is disposed a gripping means to engage into an assembly opening of the securing ring, wherein the rotary joint is placed on respective ends of the adjusting limbs opposite the ends on which are disposed the gripping means;
a spindle drive running between the adjusting limbs to alter an interval of the adjusting limbs, which are pivoted about the rotary joint, wherein the spindle drive engages in support points between the rotary joint and the ends of the adjusting limbs on which are disposed the gripping means;
wherein at least one of the adjusting limbs includes two limb sections (a, b) which are angled toward each other at an angle α, and wherein the spindle drive is placed on the adjusting limbs on the limb section (a) facing toward the gripping means.

2. Tool according to claim 1, wherein the spindle drive is formed by an adjusting spindle supported so as to rotate and swivel in the adjusting limbs, wherein in at least one of the adjusting limbs a threaded bushing is provided, which is connected in drive-movable fashion with the adjusting spindle.

3. Tool according to claim 1, wherein on the adjusting spindle an angular gear is placed for driving the adjusting spindle.

4. Tool according to claim 3, wherein the angular gear includes two ratio stages, wherein a first ratio stage is configured to be operated by a manual wheel and a second ratio stage is configured to be coupled with a motorized drive.

5. Tool according to claim 1, wherein the spindle drive includes two opposing thread sections, each of which is supported in one of the adjusting limbs in a threaded bushing.

6. Tool according to claim 1, further comprising a linear guidance placed in the adjusting limb to guide the gripping means.

7. Tool according to claim 1, wherein the gripping means are attached in replaceable fashion on the adjusting limbs.

8. Tool according to claim 1, wherein each of the gripping means includes a pin, which extends at an angle relative to the main plane of extension of the tool.

9. Tool according to claim 8, wherein the angle between the pin and the main plane of extension of the tool is a right angle.

10. Tool according to claim 2, wherein on the adjusting spindle an angular gear is placed for driving the adjusting spindle.

11. Tool according to claim 2 wherein the spindle drive includes two opposing thread sections, each of which is supported in one of the adjusting limbs in a threaded bushing.

12. Tool according to claim 3 wherein the spindle drive includes two opposing thread sections, each of which is supported in one of the adjusting limbs in a threaded bushing.

13. Tool according to claim 4 wherein the spindle drive includes two opposing thread sections, each of which is supported in one of the adjusting limbs in a threaded bushing.

14. Tool according to claim 2, further comprising a linear guidance placed in the adjusting limb to guide the gripping means.

15. Tool according to claim 3, further comprising a linear guidance placed in the adjusting limb to guide the gripping means.

16. Tool according to claim 4, further comprising a linear guidance placed in the adjusting limb to guide the gripping means.

17. Tool according to claim 5, further comprising a linear guidance placed in the adjusting limb to guide the gripping means.

18. Tool according to claim 2, wherein the gripping means are attached in replaceable fashion on the adjusting limbs.

19. Tool according to claim 3, wherein the gripping means are attached in replaceable fashion on the adjusting limbs.

20. Tool according to claim 4, wherein the gripping means are attached in replaceable fashion on the adjusting limbs.
